(19) United States
(12) Patent Application Publication
(10) Pub. No.: US 2005/0008374 A1
(43) Pub. Date: Jan. 13, 2005

(54) Optical transmitter

(75) Inventor: Yasuhisa Taneda, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokto (JP)

(21) Appl. No.: 10/914,237

(22) Filed: Aug. 10, 2004

Related U.S. Application Data
(62) Division of application No. 09/829,947, filed on Apr. 11, 2001.

(30) Foreign Application Priority Data
Apr. 13, 2000 (JP) 112158/2000

(51) Int. Cl. H04B 10/04

(52) U.S. Cl. 398/198

(57) ABSTRACT

An optical transmitter comprises a laser source, and two light-intensity modulators connected in series with the laser source. The first modulator modulates an optical signal based on a data signal and a first modulation signal. The second modulator modulates an optical signal based on a clock signal and a second modulation signal. First and second bias control circuits deliver first and second modulation signals as output, respectively. The first and second bias control circuits detect the first and second modulation signals in optical signal output respectively, and control bias voltages based on the detection results. As a consequence, optimum bias voltages are always applied independently of each other to the two light-intensity modulators.

### BACKGROUND OF THE INVENTION

1. Field of the Invention

The present invention relates to an optical transmitter which stably transmits an RZ (return-to-zero) optical signal even when a light-intensity modulator is subject to a drift in its characteristics.

2. Description of the Related Prior Art

The optical communication system where electric signals are converted into optical signals, and the optical signals are transmitted at a high speed through a fiber optic cable is being widely put into practice. The optical transmitter used in this system incorporates a light-intensity modulator which serves as a device to perform E/O conversion (electric/optical conversion). The light-intensity modulator has a property of varying its light transmission according to a bias voltage applied thereto, and performs a high-speed optical switching based on this property. As shown in FIG. 1A, an incoming optical signal can be amplified to a voltage corresponding to the difference between the minimum and maximum points of the light transmission of the light-intensity modulator. Thus, if an appropriate bias voltage is applied to the light-intensity modulator, an optical output having an optimum waveform is delivered as output (see FIG. 1B). However, the light-transmission property of the light-intensity modulator undergoes drifts under the influence of ambient changes or as a result of aging. The dotted line represents the curve of a drifted light-transmission. At this time, as shown in FIG. 1C, the optical output will have a distorted waveform. To avoid this, it is necessary to apply an appropriate bias voltage to the light-intensity modulator so that a drift in the transmission property of the light-intensity modulator may be properly canceled out.

An exemplary method of applying an appropriate bias voltage will be described below. This method is based on the fact that, when properly operated, the high and low levels of electric signals correspond with the maximum and minimum points of light transmission of the light-intensity modulator as shown in FIG. 1A. Firstly, amplitude modulation at a frequency of f0 is applied to electric signals. Because the modulated signals are folded back at the minimum and maximum points of light-transmission, the modulated signals added to optical signals will have a frequency of 2f0 as shown in FIG. 2. If the light-intensity modulator undergoes a drift in its light transmission, and the high and low levels of electric signals fall on the slope of the light transmission curve, the modulated signals added to optical signals will have an unchanged frequency of f0 as shown in FIG. 3.

If the bias voltage is kept at a proper level, electric signals obtained by converting optical signals via a light-receiving element, being fed to a band-pass filter having a central frequency of f0, will give an output having a zero amplitude (amplitude of demodulated signals). This is because demodulated signals having a frequency of 2f0 will be shut off by the filter. As the bias voltage is more apart from the optimum level, the amplitude of electric signals (amplitude of demodulated signals) passing through the filter will increase. Accordingly, if it is possible to control the bias voltage applied to the light-intensity modulator so as to keep the amplitude of demodulated signals at zero, the bias voltage will always shift in accordance with a drift in light transmission of the light-intensity modulator so as to cancel it out, and optical output with an optimum waveform will be obtained.

Japanese Patent Laid-Open No. 9-80363 discloses an exemplary RZ optical transmitter. This RZ optical transmitter comprises a laser source and a plurality of light-intensity modulators arranged in series with the laser source. Each light-intensity modulator incorporates a sign inverting circuit, driving circuit, phase detecting/bias supplying circuit and band-pass filter. Further, a low frequency oscillator is connected to the driving circuits, and phase detecting/bias supplying circuits. The RZ optical transmitter further comprises a splitting device to split optical signals having passed through the light-intensity modulators, a light-receiving device to receive a part of split optical signals to convert it into electric signals, a sign inverting circuit to invert the sign of electric signals, and a splitting circuit to split the output signal from the sign inverting circuit to send the split output to the band-pass filters.

According to this optical transmitter, the driving circuit of each light-intensity modulator applies amplitude modulation to data to be transmitted using its specific low frequency signal supplied from the low frequency oscillator. The optical output from the light-intensity modulator at the last stage is split by the splitting device. A part of split light is converted into electric signals, which are then supplied through a sign inverting circuit and splitting circuit, and each band-pass filter, to the phase detecting/bias supplying circuit of each modulator. Each band-pass filter passes low frequency signals having a frequency specified for the light-intensity modulator. Each phase detecting/bias supplying circuit detects a drift of operation point by comparing the phases of low frequency component of the optical signal output and of the low frequency wave component added by the driving circuit, and adjusts the operation point of its related light-intensity modulator. The adjustment of the operation point is simultaneously achieved for all the light-intensity modulators. Therefore, according to this RZ optical transmitter, if any one of the light-intensity modulators undergoes a drift in its light transmission, the control of bias voltages to be applied to the other light-intensity modulators will be also affected.

### SUMMARY OF THE INVENTION

In view of above, the object of this invention is to provide an RZ optical transmitter wherein, even if any one of plural light-intensity modulators undergoes a drift in its light transmission, the control of bias voltages to be applied to the other light-intensity modulators will remain unaffected.

To attain the above object, a first RZ optical transmitter comprises a laser source, and a first and second light-intensity modulators connected in series with the laser source. The RZ optical transmitter further comprises a first driving circuit to drive the first light-intensity modulator based on data signals; a second driving circuit to drive the second light-intensity modulator based on clock signals; a first control circuit to send a first modulation signal to the first driving circuit and to apply a bias voltage to the first light-intensity modulator; a second control circuit to send a second modulation signal to the second driving circuit and to apply a bias voltage to the second light-intensity modulator; and a supply means to convert light having passed through the first and second light-intensity modulators, into electric signals, and to supply the electric signals to the first and second control circuits. The first control circuit controls the bias voltage based on the first modulation signal contained in electric signals fed thereto, and the second control circuit controls the bias voltage based on the second modulation signal contained in electric signals fed thereto.

A second RZ optical transmitter comprises a laser source, and a first and second light-intensity modulators connected in series with the laser source. The RZ optical transmitter further comprises a first driving circuit to drive the first light-intensity modulator based on data signals; a second driving circuit to drive the second light-intensity modulator based on clock signals; a first control circuit to send a first modulation signal to the first driving circuit and to apply a bias voltage to the first light-intensity modulator; a second control circuit to send a second modulation signal to the second driving circuit and to apply a bias voltage to the second light-intensity modulator; and a supply means to convert light having passed through the first and second light-intensity modulators, into electric signals, and to supply the electric signals to the first and second control circuits. Further, the first control circuit comprises a modulation signal generating circuit to send a first modulation signal to the first driving circuit; an extracting means to extract the first modulation signal from electric signals fed thereto; and a circuit to control the bias voltage to be applied to the first light-intensity modulator based on the output from the extracting means. The second control circuit comprises a modulation signal generating circuit to send a second modulation signal to the second driving circuit; an extracting means to extract the second modulation signal from electric signals fed thereto; and a circuit to control the bias voltage to be applied to the second light-intensity modulator based on the output from the related extracting means. The first and second modulation signals are not in synchrony with each other, and have different frequencies.

A third RZ optical transmitter comprises a laser source, and a first and second light-intensity modulators connected in series with the laser source. The RZ optical transmitter further comprises a first driving circuit to drive the first light-intensity modulator based on data signals; a second driving circuit to drive the second light-intensity modulator based on clock signals; a first control circuit to send a first modulation signal to the first driving circuit and to apply a bias voltage to the first light-intensity modulator; a second control circuit to send a second modulation signal to the second driving circuit and to apply a bias voltage to the second light-intensity modulator; a supply means to convert light delivered by the first light-intensity modulator, into electric signals, and to provide the electric signals to the first control circuit; and another supply means to convert light delivered by the second light-intensity modulator, into electric signals, and to provide the electric signals to the second control circuit. The first control circuit controls the bias voltage based on the first modulation signal contained in electric signals fed thereto, and the second control circuit controls the bias voltage based on the second modulation signal contained in electric signals fed thereto.

A fourth RZ optical transmitter comprises a laser source, and a first and second light-intensity modulators connected in series with the laser source. The RZ optical transmitter further comprises a first driving circuit to drive the first light-intensity modulator based on data signals; a second driving circuit to drive the second light-intensity modulator based on clock signals; a first control circuit to send a first modulation signal to the first driving circuit thereby applying a bias voltage to the first light-intensity modulator; a second control circuit to send a second modulation signal to the second driving circuit thereby applying a bias voltage to the second light-intensity modulator; a supply means to convert light delivered by the first light-intensity modulator, into electric signals, and to provide the electric signals to the first control circuit; and another supply means to convert light delivered by the second light-intensity modulator, into electric signals, and to provide the electric signals to the second control circuit. Further, with regard to the fourth RZ optical transmitter, the first control circuit comprises a modulation signal generating circuit to send a first modulation signal to the first driving circuit; an extracting means to extract the first modulation signal from electric signals fed thereto; and a circuit to control the bias voltage to be applied to the first light-intensity modulator based on the output from the extracting means. Furthermore, the second control circuit comprises a modulation signal generating circuit to send a second modulation signal to the second driving circuit; an extracting means to extract the second modulation signal from electric signals fed thereto; and a circuit to control the bias voltage to be applied to the second light-intensity modulator based on the output from the extracting means. The first and second modulation signals are not in synchrony with each other, and have different frequencies.

The RZ optical transmitters configured as above always keep electric signals (data signals) to fall at an optimum bias point, thereby ensuring the stable transmission of RZ optical signals.

### BRIEF DESCRIPTION OF THE DRAWINGS

The above and other objects, features and advantages of the present invention will become apparent from the following detailed description when taken with the accompanying drawings in which:

FIG. 1A is a diagram to illustrate the light transmission characteristic of a light-intensity modulator, and the waveform of an incoming electric signal. FIGS. 1B and 1C show the waveforms of output optical signals;

FIG. 2 shows the light transmission characteristic of a light-intensity modulator, and a modulation signal;

FIG. 3 shows the light transmission characteristic of a light-intensity modulator, and a modulation signal;

FIG. 4 is a block diagram of a prior art optical transmitter;

FIG. 5 is a block diagram of an exemplary optical transmitter;

FIG. 6 is a block diagram of an exemplary bias control circuit incorporated in the optical transmitter;

FIGS. 7A to 7F show the waveforms of an RZ output signal, and the waveforms of a demodulation signal and trigger signal in the control circuit;

FIGS. 8A to 8D show the waveforms of an RZ output signal, and the waveforms of a demodulation signal and trigger signal in the control circuit;

FIGS. 9A and 9B show the waveform of an RZ output signal, and the waveforms of a demodulation and trigger signal in the control circuit;

FIG. 10A is a block diagram of a control circuit equipped with a power source for test. FIG. 10B shows the relation of a test drift voltage and a bias voltage actually applied;

FIGS. 11A to 11F show the waveforms of RZ output signals, and the waveforms of demodulation signals and trigger signals in the control circuit; and

FIG. 12 is a block diagram of a second exemplary optical transmitter.

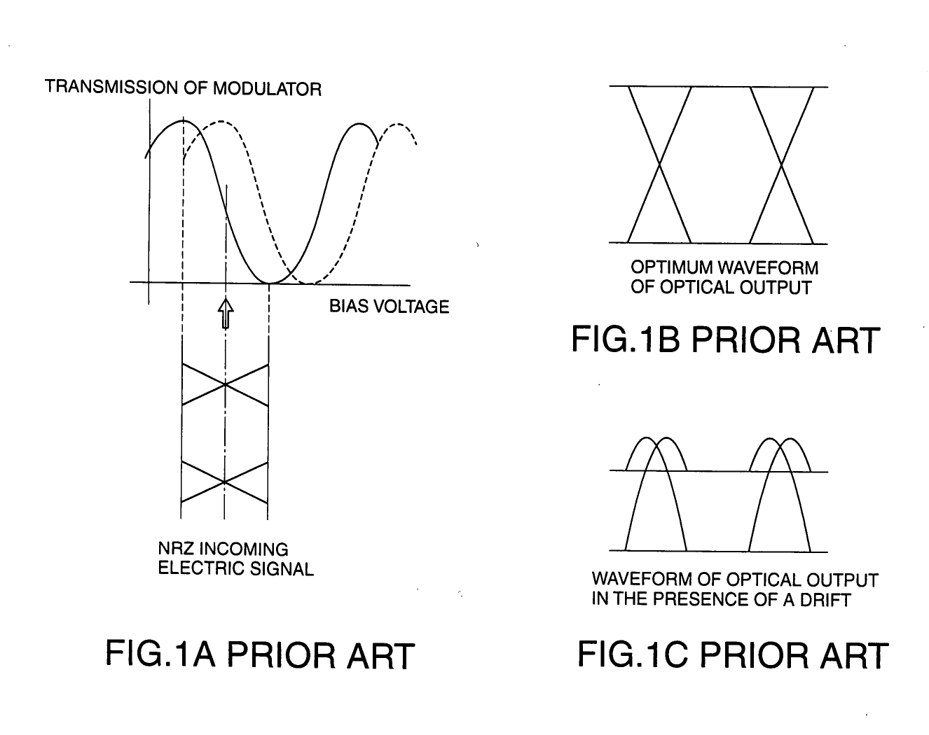

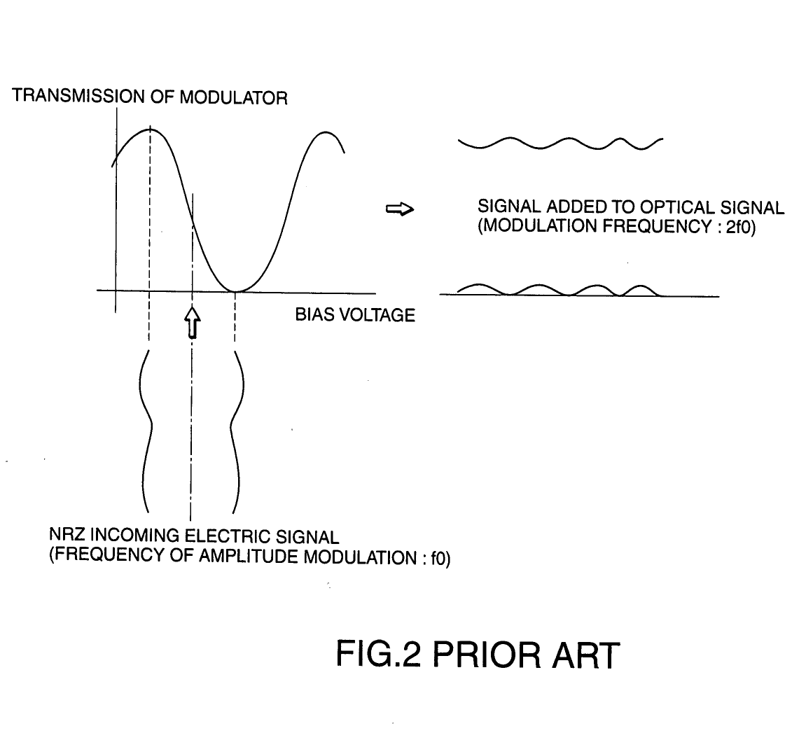

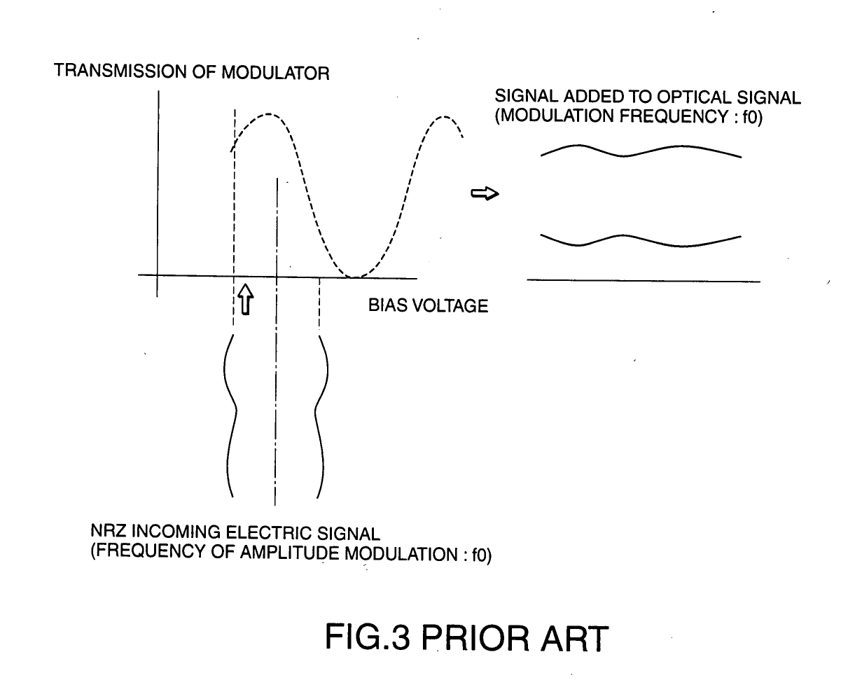

### DETAILED DESCRIPTION OF THE PREFERRED EMBODIMENTS

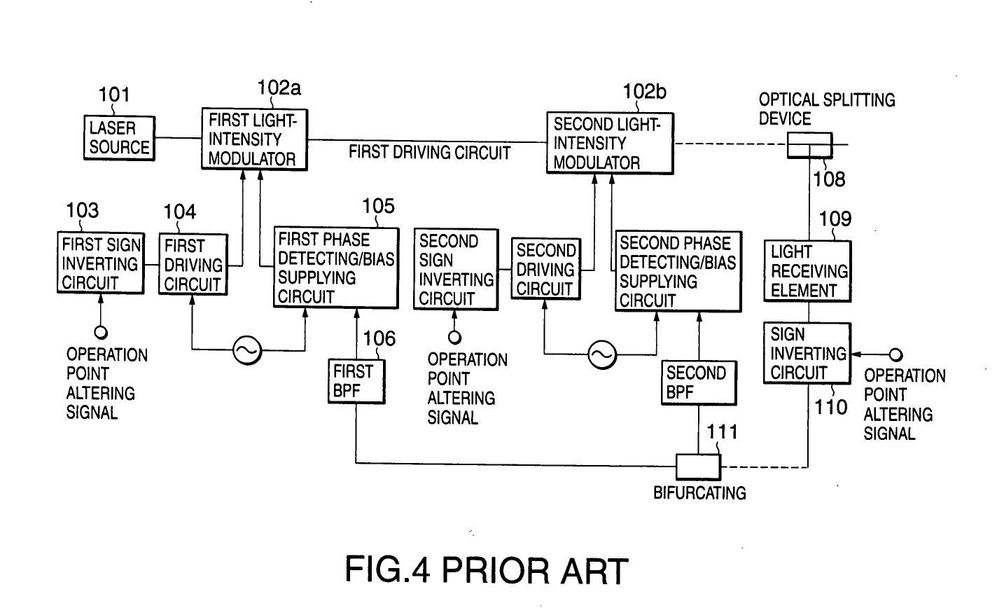

Referring to FIG. 4, a prior art RZ optical transmitter comprises a laser source 101, and a plurality of light-intensity modulators represented by light-intensity modulators 102a and 102b connected in series. To the light-intensity modulator 102a are connected a driving circuit 104, and a phase detecting/bias supplying circuit 105. A sign inverting circuit 103 to which an operation point altering signal is to be fed is connected to the driving circuit 104. A low frequency oscillator 107 sends a low frequency signal to the driving circuit 104 and the phase detecting/bias supplying circuit 105. The phase detecting/bias supplying circuit 105 receives a specified electric signal through a band pass filter (BPF) 106. Light output from this optical transmitter is split by an optical splitting device 108, and the split light is converted by a light receiving element 109 into electric signals, which are then fed through a sign inverting circuit 110 and a splitting circuit 111 to the band pass filter 106. The light-intensity modulator 102b is configured similarly to the light-intensity modulator 102a described above. According to said optical transmitter, each light-intensity modulator performs amplitude modulation using a low frequency signal with a specified frequency provided by the low frequency oscillator. Each band pass filter passes a low frequency signal with a component added by the related light-intensity modulator. Each phase detecting/bias supplying circuit compares a low frequency signal contained in the split optical signal, with a low frequency signal from the driving circuit, for their phase difference, thereby detecting the drift of operation point, and appropriately adjusts the operation point of the related light-intensity modulator. The plural light-intensity modulators perform the control of respective operation points simultaneously. Therefore, according to this RZ optical transmitter, if any one of the light-intensity modulators undergoes a drift in its light transmission, the control of bias voltages to be applied to the other light-intensity modulators will be also affected.

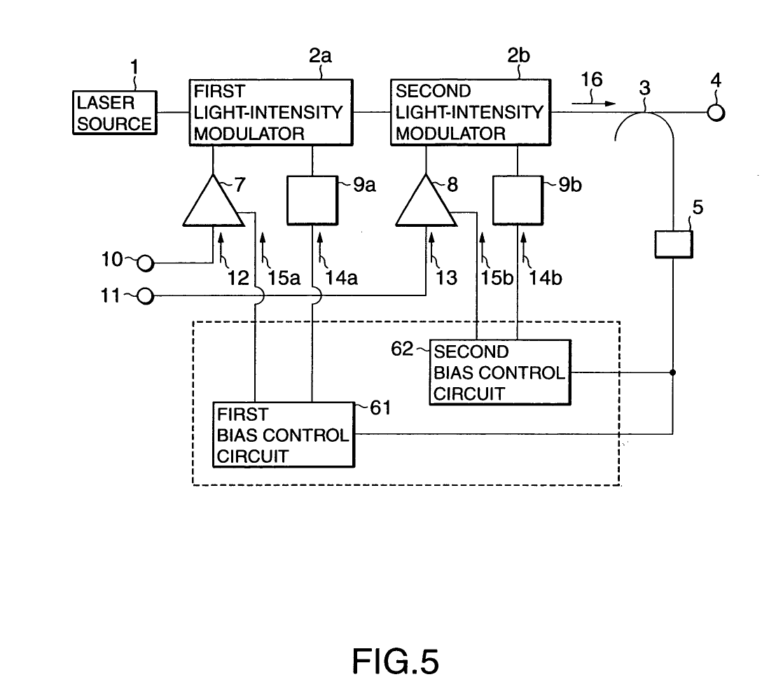

Referring to FIG. 5, an exemplary RZ optical transmitter of this invention comprises a laser source 1, and a first and second light-intensity modulators 2a and 2b connected in series with the laser source 1.

To the first light-intensity modulator 2a is connected a first driving circuit 7 which drives the modulator 2a based on data signals 12. The first light-intensity modulator 2a is further provided with a first bias control circuit 61 which sends a first modulation signal 15a to the first driving circuit 7, and an optimum bias voltage 14a to the modulator 2a. To the second light-intensity modulator 2b is connected a second driving circuit 8 (clock-based modulator) which drives the modulator 2b based on clock signals 13. The second light-intensity modulator 2b is further provided with a second bias control circuit 62 which sends a second modulation signal 15b to the second driving circuit 2b, and an optimum bias voltage 14b to the modulator 2b. Optical signals having passed through the first and second light-intensity modulators 2a and 2b are split by an optical coupler 3. One part of optical signals split by the optical coupler is delivered as output by an optical output portion 4. The other part of split optical signals is fed to a photo-diode 5 where the signals are converted into electric signals. A voltage applying device 9a may be inserted between the first light-intensity modulator 2a and the first bias control circuit 61. Similarly, a voltage applying device 9b may be inserted between the second light-intensity modulator 2b and the second bias control circuit 62.

Said RZ optical transmitter will operate as follows. Data signals 12 entering through a data signal entry portion 10 are fed to the first driving circuit where they are amplified so as to have an optimum amplitude. The first driving circuit 7 drives the first light-intensity modulator 2a so that light signals may be modulated by the amplified data signals. The data signals are a non-return-to-zero (NRZ) signal. Clock signals entering through a clock signal entry portion 11 is fed to the clock-based modulator 8 where they are amplified so as to have an optimum amplitude. The clock-based modulator 8 drives the second light-intensity modulator 2b where light signals are modulated by the amplified clock signals. Through these operations, the first and second light-intensity modulators 2a and 2b performs NRZ data modulation and clock-based modulation via the first driving circuit 7 and clock-based modulator 8, respectively. As a result, CW light emitted from the laser source 1 turns into an RZ signal. The optical coupler 3 splits optical signals 16 delivered by the second light-intensity modulator 2b. One part of the split light signals is delivered as output by the optical output portion 4, and the other part is received by the photodiode 5. The first bias control circuit 61 receives electric signals provided by the photodiode 5, generates an optimum bias voltage based on the electric signals, and sends the voltage to the first light-intensity modulator 2a. If a voltage applying device 9a is inserted, the bias voltage 14a will be provided to that device 9a. The first bias control circuit 61 provides a first modulation signal 15a to the first driving circuit 7. The first driving circuit 7 drives the first light-intensity modulator 2a where light signals are modulated by the modulation signal 15a. The second bias control circuit 62 operates in the same manner as above, but independently of the above.

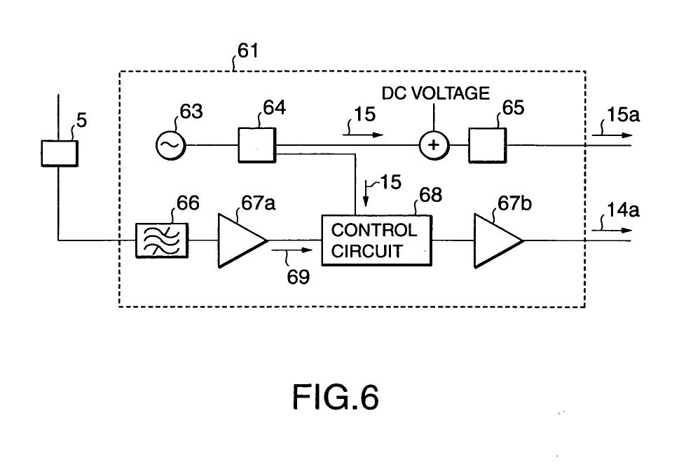

Referring to FIG. 6, the first bias control circuit 61 comprises an oscillator 63, a frequency divider 64 to reduce the frequency of a signal generated by the oscillator 63 to a specified level, and a transistor 65 to add a DC voltage to a modulation signal generated by the frequency divider 64, thereby producing a first modulation signal 15a as output. The first bias control circuit 61 further comprises a band pass filter 66 to receive electric signals from the photodiode 5, a first amplification transistor 67a, a control circuit 68 to receive an amplified output signal 69 and to deliver a bias voltage as output, and a second transistor 67b to amplify output from the control circuit 68, thereby producing a bias voltage 14a. The second bias control 62 is configured similarly to the above, except that the frequencies of modulation signals (the frequencies of signals generated by the respective oscillators 63 or the ratios of division worked by the respective frequency dividers 64), the central frequencies of respective band pass filters and the gains of first and second transistors are different between the two bias control circuits.

First bias control circuit 61 will operate as follows. The oscillator generates a signal having a specified frequency. The frequency divider 64 reduces the frequency of the signal to a specified level, thereby producing a modulation signal 15. The transistor 65 adds a DC voltage to the modulation signal 15, thereby producing a first modulation signal 15a as output. The first driving circuit 7 drives the first light-intensity modulator 2a, thereby modulating light signals based on the first modulation signal 15a. The band pass filter 66 passes electric signals having a specified frequency delivered by the photodiode 5, and the first amplification transistor 67a amplifies the signal and sends it as a demodulation signal 69 to the control circuit 68. The control circuit which has received a first modulation signal 15 from the frequency dividing circuit 64, uses this modulation signal 15 as a trigger signal to control the output so that the amplitude of demodulation signal 69 may be kept at zero. A bias voltage provided by the control circuit 68 is amplified by the second amplification transistor 67b, which is then provided to the first bias voltage applying device 9a as a bias voltage 14a. For the first bias control circuit, the frequency of the first modulation signal 15a and the central frequency of the band pass filter are in agreement. The second bias circuit 62 operates similarly to above.

With regard to the above examples depicted in FIGS. 5 and 6, their operation conditions are, for example, as follows.

Data signals 12 are an NRZ electric signal with an amplitude of 1.0 Vpp transmitted at 10.8 Gb/s. The first driving circuit amplifies the data signal 12 to allow it to have an amplitude of 4.5 Vpp. Clock signals 13 occur as a wave having a frequency of 10.8 GHz and an amplitude of 1.0 Vpp. The clock signal 13 is amplified by a clock-based modulator 8 comprising a stack of FETs so that it may have an amplitude of 4.5 Vpp at maximum. The first driving circuit 7 and clock-based modulator 8 of this example are kept under their respective automatic gain controls (AGC), and thus their outputs are kept constant independently of the ambient temperatures. Both the data signal and the clock signal are adjusted in advance so that an RZ optical signal having an optimum waveform may be obtained. The laser source 1 is a DFB-LD to emit a laser beam having a wavelength λs=1558.5 nm and a power of +8d Bm. The first and second light-intensity modulators consist of an LN (LiNbO3) light-intensity modulator with a band width of about 7 GHz and a half-wave voltage of 4.5 Vpp. The split ratio of the photo-coupler is 10:1. The photodiode 5 is made of an InGaAs-PIN photodiode. The oscillator 63 of the first bias control circuit 61 generates a wave with a frequency of 1.5 MHz, and the frequency divider reduces the frequency to 6 kHz, and provides a first modulation signal 15 with the frequency of 6 kHz to the transistor 65 and the control circuit 68. The band pass filter of the first bias control circuit 61 has a central frequency of 6 kHz and a Q-value of about 10. The first and second amplification transistors 67a and 67b of the first bias control circuit 61 permit 50- and 430-fold gains respectively. The oscillator 63 of the second bias control circuit 62 generates a wave having a frequency of 5.0 MHz, and the frequency divider 64 reduces the frequency to 10 kHz, and provides a modulation signal 15 with the frequency of 10 kHz to the transistor 65 and the control circuit 68. The band pass filter 66 of the second bias control circuit 62 has a central frequency of 10 kHz and a Q-value of about 10. The first and second amplification transistors 67a and 67b of the second bias control circuit 62 permit 150- and 300-fold gains respectively. The band pass filter 66 and control circuit 68 may be prepared from operational amplifiers and ICs used for general purposes.

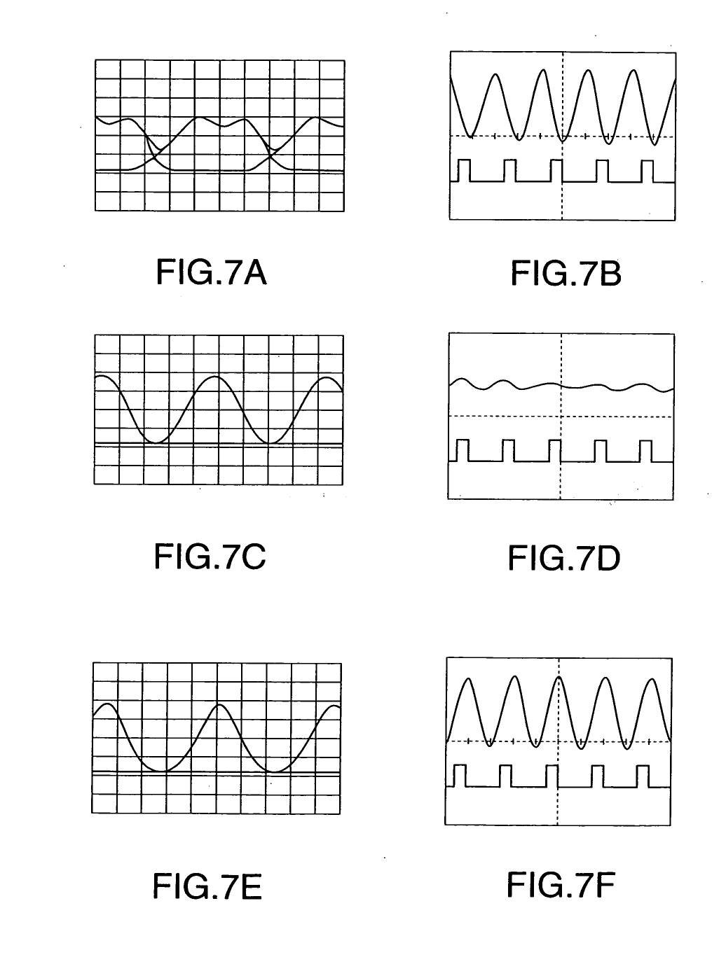

FIGS. 7A to 7F show the waveforms of an RZ optical output and demodulation signal, and a trigger signal in response to a change in bias voltage. In this example, the bias voltage is manually altered. The waveforms of RZ optical signal 16 when the bias voltage applied to the second light-intensity modulator 2b is altered are represented in FIGS. 7A, 7C and 7E, while the waveforms of demodulation signal 69 and trigger signal (10 kHz) of the second bias control circuit 62 are represented in FIGS. 7B, 7D and 7F. As shown in FIGS. 7C and 7D, if the RZ optical signal has an optimum waveform, the demodulation signal 69 in the second bias control circuit 62 will have an amplitude of about 0 mvpp, and is stabilized there. If the bias voltage is shifted from an optimum point, the RZ optical signal is distorted, and the wave of demodulation signal 69 occurring at the frequency of 10 kHz have an increased amplitude up to 3 Vpp or higher (FIGS. 7A, 7B, 7E and 7F). What is described above also applies to the bias voltage applied to the first light-intensity modulator 2a. If the RZ optical signal has an optimum waveform, the demodulation signal 69 in the first bias control circuit 61 has an amplitude of about 0 mvpp. If the bias voltage is shifted from an optimum point, the wave of demodulation signal 69 occurring at the frequency of 10 kHz has an increased amplitude.

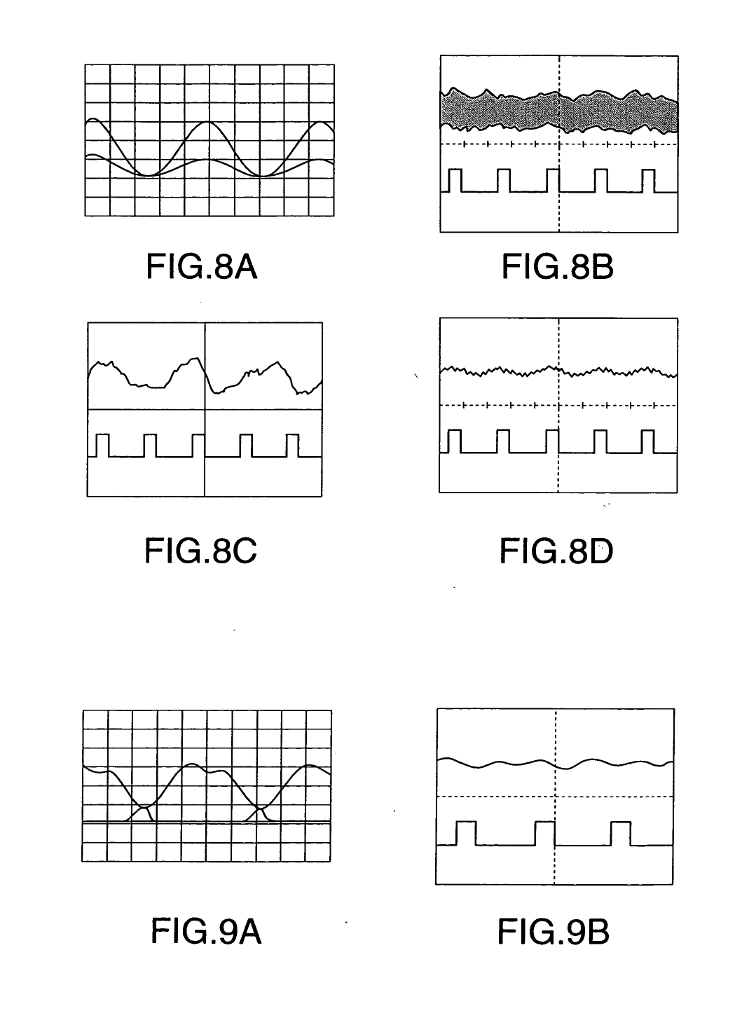

FIGS. 8A to 8D represent the waveforms of RZ optical signal 16, and the waveforms of demodulation signal 69 of the second bias control circuit 62 when the bias voltage applied to the first light-intensity modulator 2a is altered. The demodulation signal 69 having passed through the band pass filter 66 with a central frequency of 10 kHz installed in the second bias control circuit 62 contains a small amount of components having the frequency of demodulation signal originated from the first light-intensity modulator 2a. The component with the frequency of demodulation signal is amplified by the first amplification transistor 67a, and thus it gives a noise having an amplitude of 1 Vpp and a frequency of 6 kHz as depicted in FIG. 8C. This suggests, if the bias voltage applied to the first light-intensity modulator 2a is altered, it would give an adverse effect on the second bias control circuit 62 unless properly treated. However, because the noise component (6 kHz) is not synchronous with the trigger signal (10 kHz), the demodulation signal 69 will take a waveform as shown in FIG. 8B. Namely, the waveforms observed on the screen of a meter appear to move in a transverse direction. The bias voltage must be a DC voltage. If the demodulation signal is averaged, the fluctuated component will have an amplitude of approximately 0 mvpp as shown in FIG. 8D. In other words, even if a noise component arises in the demodulation signal, the noise component will be canceled out provided that the demodulation component is averaged over time. Thus, an alteration of the bias voltage applied to the first light-intensity modulator 2a will not have an adverse effect on the second bias control circuit 62. The second bias control circuit 62 will be kept under proper control.

FIGS. 9A and 9B represent the waveforms of RZ optical signal 16, and the waveforms of demodulation signal 69 of the first bias control circuit 61 and of the trigger signal (6 kHz) when the bias voltage applied to the second light-intensity modulator 2b is altered. The band pass filter 66 with a central frequency of 6 kHz installed in the first bias control circuit 61 thoroughly shuts off the components having a frequency of 10 kHz, and the first and second amplification transistors 67a and 67b permit comparatively low gains. Therefore, even if the bias voltage applied to the second light-intensity modulator 2b is altered, the modulation signal 69 will have an amplitude of 0 mvpp (FIG. 9B). If a noise having a frequency of 10 kHz arises in the demodulation signal, the first bias control circuit 61 will be kept under proper control in the manner as described with reference to FIGS. 8A to 8D.

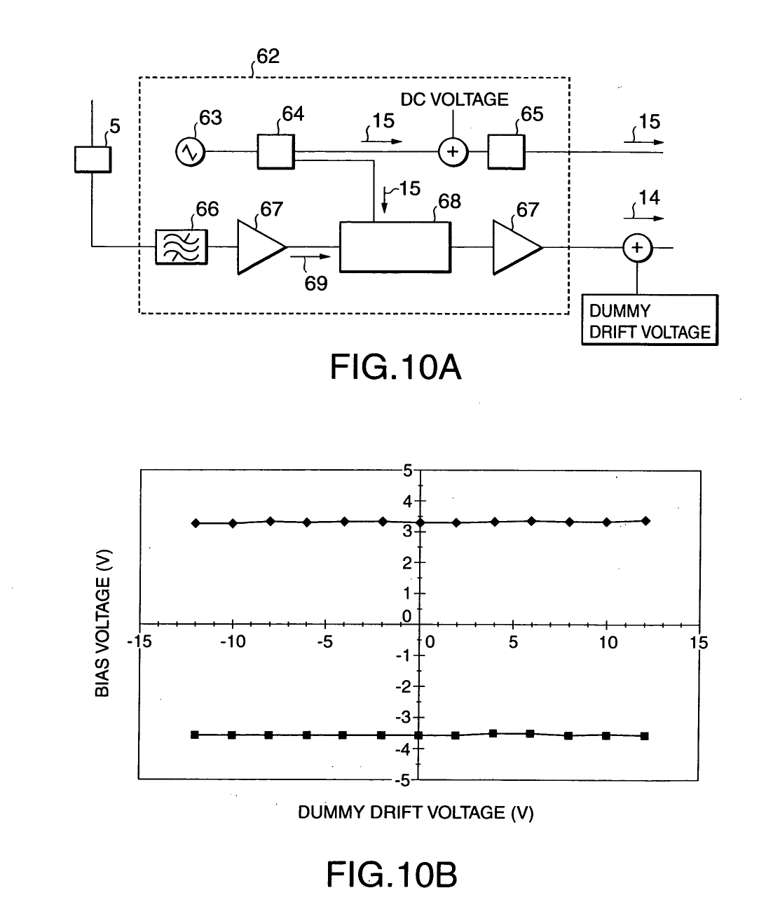

Referring to FIG. 10A, a test circuit to forcibly effect a drift in the light transmission of a light-intensity modulator is represented by, for example, a circuit where a power source 70 for giving a dummy drift is connected to the first bias control circuit 61. This power source 70 adds a dummy drift voltage to a bias voltage 14a. FIG. 10B shows how the bias voltage applied to the first light-intensity modulator 2a is stably kept constant even when the dummy drift voltage added to the bias voltage is varied. Thus, even if the dummy drift voltage is varied between −12V and +12V, the bias voltage 14a applied to the first light-intensity modulator is stably kept at about +3.21V. This also applies to a bias voltage 14b applied to the second light-intensity modulator 2b which is stably kept close to −3.66V even if the dummy voltage added thereto is varied.

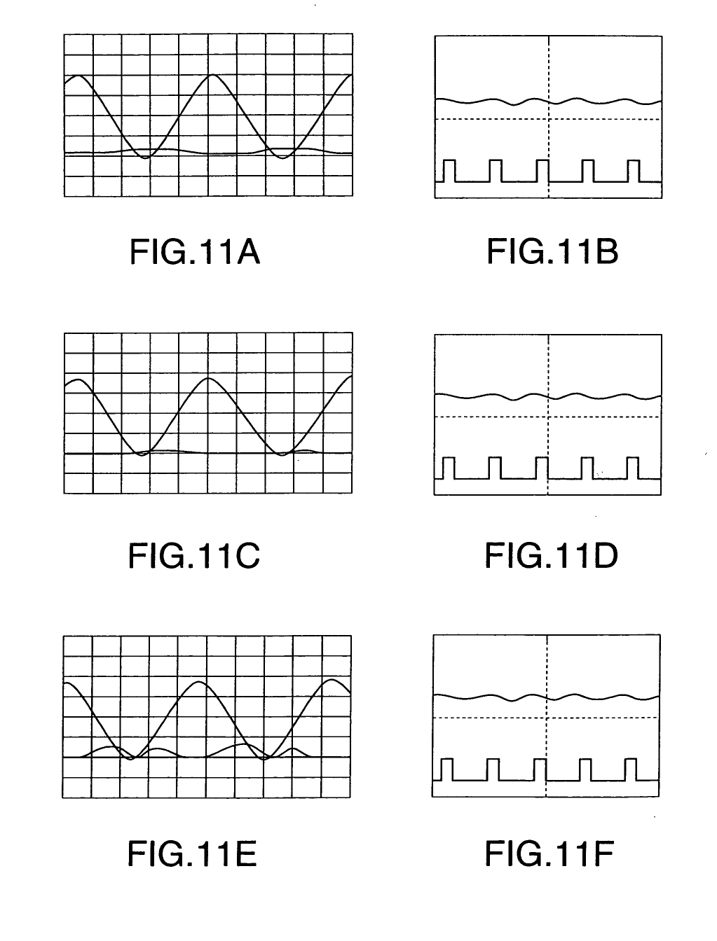

FIGS. 11A to 11F show the waveform of RZ optical signal 16 and the waveform of demodulation signal 69 of the second bias control circuit 62 when the ambient temperature is varied between 55 and 5° C. FIGS. 11A and 11B show the waveforms at 55° C., FIGS. 11C and 11D the waveforms at 25° C., and FIGS. 11E and 11F the waveforms at 5° C. These figures demonstrate that the demodulation signal 69 has an amplitude of nearly 0 Vpp, and the RZ optical signal 16 has a waveform free from distortions, even when the temperature is varied in the above range. The demodulation signal 69 of the first bias control circuit 61 also has its amplitude kept at zero (not illustrated).

If a modulation signal with a frequency of 6 kHz is fed to the first driving circuit 7, and another modulation signal with a frequency of 3 kHz is fed to the clock-based modulator 8, a noise with a frequency of 3 kHz will arise. In this case, an alteration in the bias voltage applied to the first light-intensity modulator 2a may have an adverse effect on the second bias control circuit 62. An alteration in the bias voltage applied to the second light-intensity modulator 2b, however, apparently has no adverse effect on the first bias control circuit 61. This is because the modulation signals having frequencies of 3 and 6 kHz give rise to a noise having a frequency equal to the difference of 3 and 6 kHz, and thus the noise can not be distinguished from the deliberately inserted demodulation signal with the frequency of 3 kHz. To avoid this, it is preferable to make the noise have a frequency (difference of involved frequencies, or their harmonics) distinguishable from the frequencies of the demodulation signals deliberately inserted.

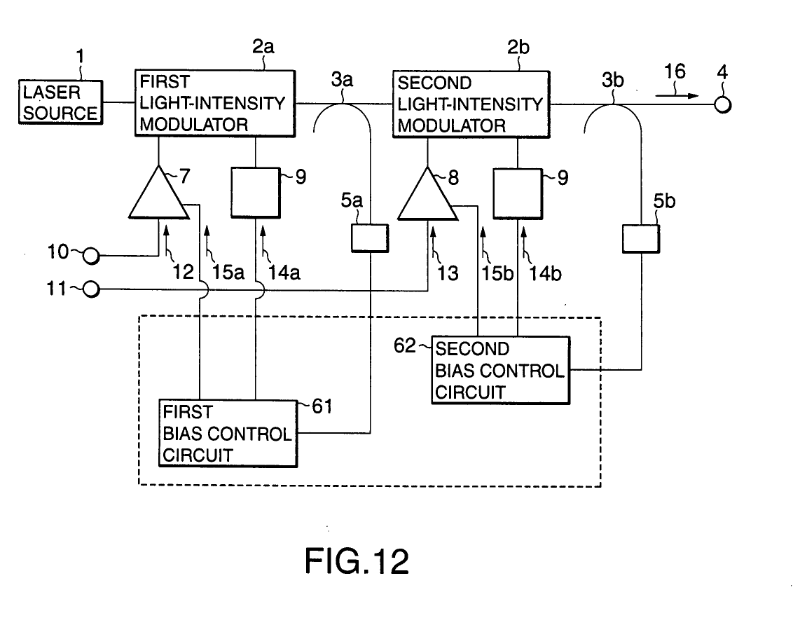

FIG. 12 shows another exemplary RZ optical transmitter. The basic composition of this RZ optical transmitter is the same with what is shown in FIG. 5. The RZ optical transmitter comprises a laser source 1, and a first and second light-intensity modulators 2a and 2b connected in series with the laser source 1. Between the first and second light-intensity modulators 2a and 2b is inserted a photo-coupler 3a which branches out optical signals having passed through the first light-intensity modulator 2a. The split light prepared by the photo-coupler 3a is received by a first photo-diode 5a where it is converted into electric signals, which are then sent to a first bias control circuit 61. Behind the second light-intensity modulator 2b is placed another photo-coupler 3b which branches out optical signals having passed through the second light-intensity modulator 2b. The split light prepared by the photo-coupler 3b is received by a second photo-diode 5b where it is converted into electric signals, which are then sent to a second bias control circuit 62. The first and second light-intensity modulators 2a and 2b may be positioned as opposite to what is depicted in FIG. 12.

As detailed above, according to the RZ optical transmitter of this invention, even if the bias voltage applied to the first light-intensity modulator and the bias voltage applied to the second light-intensity modulator are subject to alterations, the first and second bias control circuits will remain unaffected. Further, even if the temperature of the environment around the optical transmitter varies, or the light-intensity modulator is subject to an alteration in its light transmission characteristic, optimum bias voltages will be stably applied to the two light-intensity modulators independently of each other.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

1.-7. (Canceled)

8. An optical transmitter for transmitting a return-to-zero signal comprising:
a laser source;
a first light-intensity modulator and a second light-intensity modulator connected in series with the laser source;
a first driving circuit to drive the first light-intensity modulator based on a data signal;
a second driving circuit to drive the second light-intensity modulator based on a clock signal;
a first control circuit to send a first modulation signal to the first driving circuit, to apply a bias voltage to the first light-intensity modulator;
a second control circuit to send a second modulation signal to the second driving circuit, to apply a bias voltage to the second light-intensity modulator;
a supply means to convert light delivered by the first-intensity modulator, into an electric signal, and to provide the electric signal to the first control circuit; and
another supply means to convert light delivered by the second light-intensity modulator, into an electric signal, and to provide the electric signal to the second control circuit, wherein:
the first control circuit controls the bias voltage based on the first modulation signal contained in the electric signal fed thereto, and the second control circuit controls the bias voltage based on the second modulation signal contained in the electric signal fed thereto.

9. An optical transmitter for transmitting a return-to-zero optical signal comprising:
a laser source;
a first light-intensity modulator and a second light-intensity modulator connected in series with the laser source;
a first driving circuit to drive the first light-intensity modulator based on a data signal;
a second driving circuit to drive the second light-intensity modulator based on a clock signal;
a first control circuit to control the first driving circuit, in order to apply a bias voltage to the first light-intensity modulator;
a second control circuit to control the second driving circuit, in order to apply a bias voltage to the second light-intensity modulator;
a supply means to convert light delivered by the first light-intensity modulator, into an electric signal, and to provide the electric signal to the first control circuit; and
another supply means to convert light delivered by the second light-intensity modulator, into an electric signal, and to provide the electric signal to the second control circuit, wherein:
the first control circuit comprises a modulation signal generating circuit to send a first modulation signal to the first driving circuit, an extracting means to extract the first modulation signal from the electric signal fed thereto, and a circuit to control a bias voltage to be applied to the first light-intensity modulator based on the output from the extracting means;
the second control circuit comprises a modulation signal generating circuit to send a second modulation signal to the second driving circuit, an extracting means to extract the second modulation signal from the electric signal fed thereto, and a circuit to control a bias voltage to be applied to the second light-intensity modulator based on the output from the extracting means; and
the first and second modulation signals are not synchronous with each other and have different frequencies.

10. An optical transmitter as described in claim 9, wherein:
the first and second modulation signals have frequencies different from that of a noise signal.

11. An optical transmitter as described in claim 9 wherein:
the circuit to control a bias voltage applied to the first light-intensity modulator controls the bias voltage so that the output from the extracting means may approach zero; and
the circuit to control a bias voltage applied to the second light-intensity modulator controls the bias voltage so that the output from the extracting means may approach zero.

12. An optical transmitter as described in claim 9 wherein:
the first light-intensity modulator and the second light-intensity modulator are connected in series with the laser source in this order.

13. An optical transmitter as described in claim 9 wherein:
the second light-intensity modulator and the first light-intensity modulator are connected in series with the laser source in this order.

14. An optical transmitter as described in claim 9 wherein:
the supply means comprises an optical splitting device, and a light receiving element to convert one part of split light into an electric signal.
